(19) United States
(12) Patent Application Publication
(10) Pub. No.: US 2014/0229796 A1
(43) Pub. Date: Aug. 14, 2014

(54) Electronic Control Apparatus

(71) Applicant: Hitachi Automotive Systems, Ltd., Hitachinaka-shi, Ibaraki (JP)

(72) Inventors: Kohei Sakurai, Tokyo (JP); Fumio Narisawa, Tokyo (JP); Masahiro Matsubara, Tokyo (JP); Wataru Nagaura, Hitachinaka (JP)

(73) Assignee: Hitachi Automotive Systems, Ltd., Ibaraki (JP)

(21) Appl. No.: 14/348,649

(22) PCT Filed: Oct. 3, 2012
(86) PCT No.: PCT/JP2012/075594

§ 371 Date: Mar. 31, 2014

(30) Foreign Application Priority Data
Oct. 17, 2011 (JP) 2011-228173

(51) Int. Cl. G06F 11/10

(52) U.S. Cl. CPC G06F 11/1076
USPC 714/764

(57) ABSTRACT

An electronic control apparatus having a highly reliable memory capable of holding down the memory use quantity is provided.

In the electronic control apparatus according to the present invention, data after error correction is retained in a second storage area different from a first storage area where a data error is detected, data on the second storage area is used for control processing and data on the first storage area is also used for control processing continuously.

### TECHNICAL FIELD

The present invention relates to an electronic control apparatus which controls operation of a device electronically.

### BACKGROUND ART

In recent years, it has become general to control devices such as automobiles, construction machinery, and elevators electronically by using electronic control apparatuses each including an input circuit, a microcontroller, an output circuit, and a power supply circuit. The electronic control apparatus is an apparatus that receives input signals from various sensors, causes the microcontroller to execute control computation on the basis of a program and data incorporated in a memory, and drives the output circuit to control various actuators and switches, in order to bring the device into an optimum operation state.

Recently, size shrinking of the memory increases possibility of occurrence of failures in which a program and data values incorporated in the memory are changed without intension by influence of a trouble at the time of manufacture, noise and radiation. Since the electronic control apparatus executes the control computation on the basis of the program and data, there is a fear that it will not be able to control the device safely if a failure occurs.

In PTL 1 stated below, a redundant data area for error detection is provided apart from an ordinary data area where data to be used for control is retained, and data in the data area is inspected on the basis of data in the redundant data area, in order to avoid the malfunction described above. As a result, it is possible to detect an error in data in the data area. If an error is detected, predetermined fixed data is output instead of erroneous data.

PTL 2 stated below discloses a method of conducting error correction on data in an address for which an error is detected, in a memory having the known error checking and correction (ECC) function, and retaining resultant data in a different address in a vacant area in the memory. A storage area where the error is detected is not used thereafter. Citation List

### PATENT LITERATURE

PTL 1: JP 2010-102686 A

PTL 2: JP 2009-506445 W

### SUMMARY OF INVENTION

### Technical Problem

In recent years, data to be ensured in reliability in order to control the device safely tend to increase with advance of electronic control. In a scheme in which a redundant data area is provided apart from an ordinary data area as in the technique described in PTL 1, therefore, there is a problem that the memory use quantity increases.

On the other hand, in the scheme described in PTL 2, a failure does not occur in every memory cell. Therefore, the memory use quantity can be made smaller as compared with the scheme in which all data are made redundant and retained as in PTL 1. Once a failure occurs, however, it is necessary in PTL 2 to make a memory cell in which the failure has occurred unusable and, in addition, previously secure a vacant area of a determinate quantity depending upon a failure rate. Considering that lasting hardware failures are rare among memory failures and almost all memory failures are temporary failures caused by noise, radiation or the like, it is considered that such a scheme has room for improvement from the viewpoint of the utilization efficiency of the memory.

In order to solve the problems described above, the present invention has been achieved. It is an object of the present invention to provide an electronic control apparatus having a highly reliable memory capable of holding down the memory use quantity.

### Solution to Problem

In the electronic control apparatus according to the present invention, data after error correction is retained in a second storage area different from a first storage area where a data error is detected, data on the second storage area is used for control processing and data on the first storage area is also used for control processing continuously.

### Advantageous Effects of Invention

When a data error is detected in the electronic control apparatus according to the present invention, data after error correction is stored in the second storage area. Therefore, it is not necessary to previously secure a storage area for storing data after error correction. Furthermore, the first storage area where the data error is detected is also used continuously. In a case where a cause of the data error is temporary as described above, therefore, it is possible to restore the use situation of the storage areas to a state before occurrence of the data error by, for example, deleting data retained on the second storage area when the error occurrence rate has fallen. Therefore, it is possible to hold down the memory use quantity while ensuring the reliability of the memory.

### BRIEF DESCRIPTION OF DRAWINGS

FIG. 1 is a functional block diagram of an electronic control apparatus 1 according to Embodiment 1.

FIG. 2 is a diagram showing a configuration of a program and data stored in a ROM 11.

FIG. 3 is a diagram showing a data arrangement in the ROM 11 before and after a memory failure occurs.

FIG. 4 is a diagram showing a processing flow at time when the electronic control apparatus 1 reads data stored in a data retention unit 21.

FIG. 5 is a diagram showing a processing flow at time when the electronic control apparatus 1 uses data after correction, after the data after correction is retained on a second storage area A2 by the processing flow shown in FIG. 4.

FIG. 6 is a diagram showing a configuration of a program and data stored in a ROM 11 included in an electronic control apparatus 1 according to Embodiment 2.

FIG. 7 is a diagram showing a data arrangement in the ROM 11 before and after a memory failure occurs in Embodiment 2.

FIG. 8 is a diagram showing a processing flow at time when the electronic control apparatus 1 reads data stored in a data retention unit 21 in Embodiment 2.

FIG. 9 is a diagram showing a processing flow at time when an electronic control apparatus 1 reads data stored in a data retention unit 21 in Embodiment 3.

### DESCRIPTION OF EMBODIMENTS

### Embodiment 1

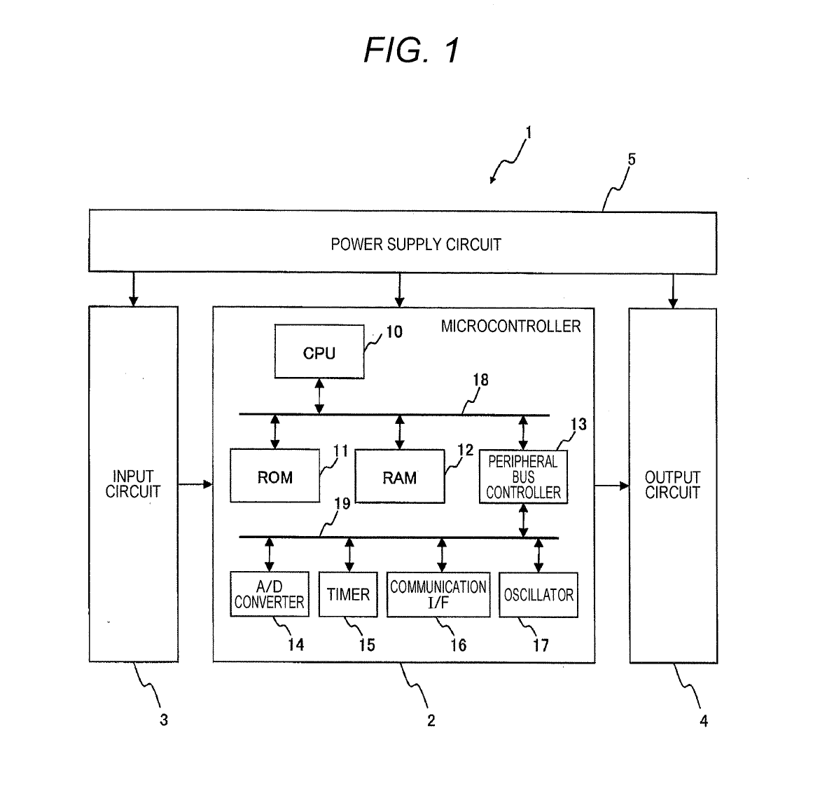

FIG. 1 is a functional block diagram of an electronic control apparatus 1 according to Embodiment 1 of the present invention. The electronic control apparatus 1 is an apparatus which controls a device electronically. The electronic control apparatus 1 includes a microcontroller 2, an input circuit 3, an output circuit 4, and a power supply circuit 5.

The microcontroller 2 includes a CPU (Central Processing Unit) 10, a ROM (Read Only Memory) 11, a RAM (Random Access Memory) 12, a peripheral bus controller 13, an A/D converter 14, a timer 15, a communication interface (I/F) 16, and an oscillator 17. The CPU 10, the ROM 11, the RAM 12, and the peripheral bus controller 13 are connected to an internal bus 18. The A/D converter 14, the timer 15, the communication interface (I/F) 16, the oscillator 17, and the peripheral bus controller 13 are connected to a peripheral bus 19.

The CPU 10 receives input signals via the input circuit 3 from various sensors or another electronic control apparatus, executes a program stored in the ROM 11 or the RAM 12 by utilizing functions of the A/D converter 14, the timer 15, the communication interface (I/F) 16 and the like, and executes control processing by using data stored in the ROM 11 or the RAM 12. Furthermore, as a part of the control processing, the CPU 10 drives the output circuit 4 to control various actuators and switches and bring the device into optimum operation, or transmit control data to another electronic control apparatus via the communication interface 16 in some cases.

The ROM 11 stores a program executed by the CPU 10 and data used in the program. In a case where it is necessary to rewrite data or the like stored in the ROM 11, a rewritable ROM such as a flash ROM is used. The RAM 12 temporarily stores data used by the CPU 10 in a process of executing the program. For example, the CPU 10 develops the program and data stored in the ROM 11 onto the RAM 12 and uses the program and data. In FIG. 1, the ROM 11 and the RAM 12 are incorporated in the microcontroller 2. However, the ROM 11 and the RAM 12 may be provided outside the microcontroller 2.

The peripheral bus controller 13, the A/D converter 14, the timer 15, the communication interface (I/F) 16, and the oscillator 17 are those included in a general electronic control apparatus. The output circuit 4 receives a control signal from the electronic control apparatus 1, and outputs a drive signal to a device controlled by the electronic control apparatus 1.

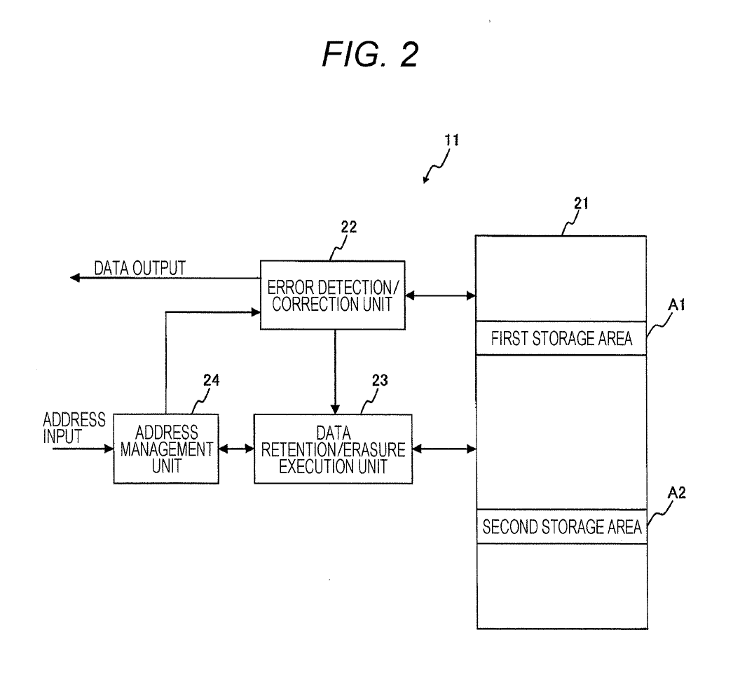

FIG. 2 is a diagram showing a configuration of the program and data stored in a ROM 11. The ROM 11 stores a data retention unit 21, an error detection/correction unit 22, a data retention/erasure execution unit 23, and an address management unit 24. In the case where the data and the like stored in the ROM 11 are developed onto the RAM 12, the RAM 12 also stores the data and the like in the same way as FIG. 2.

The data retention unit 21 includes a plurality of data storage areas, i.e., a plurality of memory cells. The data retention unit 21 stores data used by the CPU 10 when executing the control processing. The data retention unit 21 includes a first storage area A1 and a second storage area A2 described later.

The error detection/correction unit 22 inspects whether a data error is generated in data stored by the data retention unit 21 by using an error detection/correction code added to the data. In a case where an error is generated and the number of erroneous bits is within a range in which correction using the error detection/correction code is possible, the error detection/correction unit 22 corrects the error. Since this error detection/correction function is known, detailed description will be omitted.

If the data retention/erasure execution unit 23 receives notice to the effect that a data error is detected in the first storage area A1 in the data retention unit 21, from the error detection/correction unit 22, the data retention/erasure execution unit 23 retains data stored in the first storage area A1 into the second storage area A2. Furthermore, under a predetermined condition, the data retention/erasure execution unit 23 erases data retained in the second storage area A2. These processing flows will be described later.

The address management unit 24 receives from the data retention/erasure execution unit 23 an address of the second storage area A2 and, for example, notice to the effect that data retained in the second storage area A2 is erased, and manages correspondence relations between addresses of data stored in the first storage area A1 and addresses of corresponding data stored in the second storage area A2. The CPU 10 can access these data without being conscious of a change in data arrangement caused by a processing flow described later by inquiring of the address management unit 24 about correspondence relations of these data.

The error detection/correction unit 22, the data retention/erasure execution unit 23, and the address management unit 24 can be constituted by using hardware such as circuit devices which implement these functions, or can be implemented by causing the CPU 10 to execute software which describes processing of these function units. Ina case where these function units are mounted as software, these memory units can be stored on the memory as shown in FIG. 2.

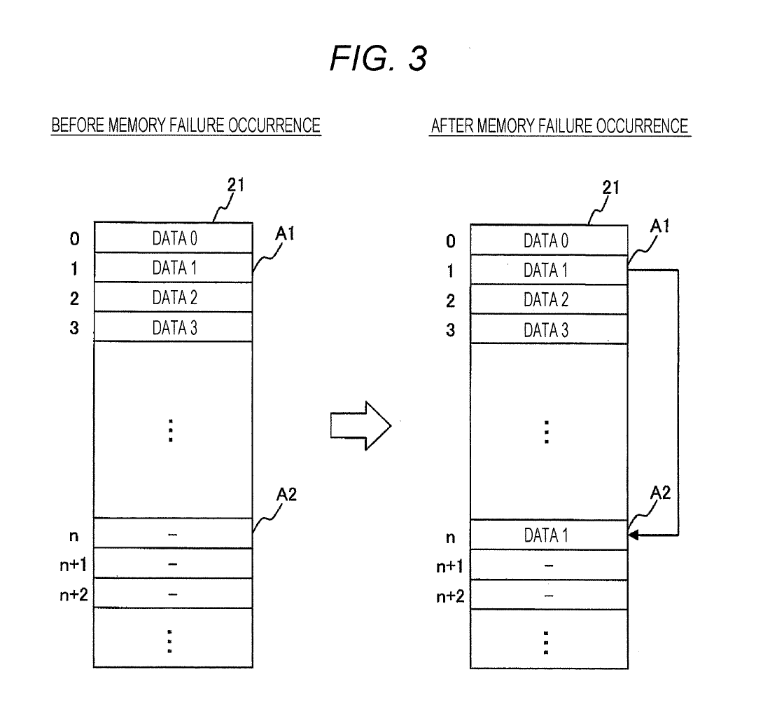

FIG. 3 is a diagram showing a data arrangement in the ROM 11 before and after a memory failure occurs. It is supposed that data 0, data 1, . . . , are already stored respectively in address 0, address 1, . . . , in the data retention unit 21 at a time point before occurrence of a failure, and a failure has occurred in a memory cell in the address 1 (=the first storage area A1).

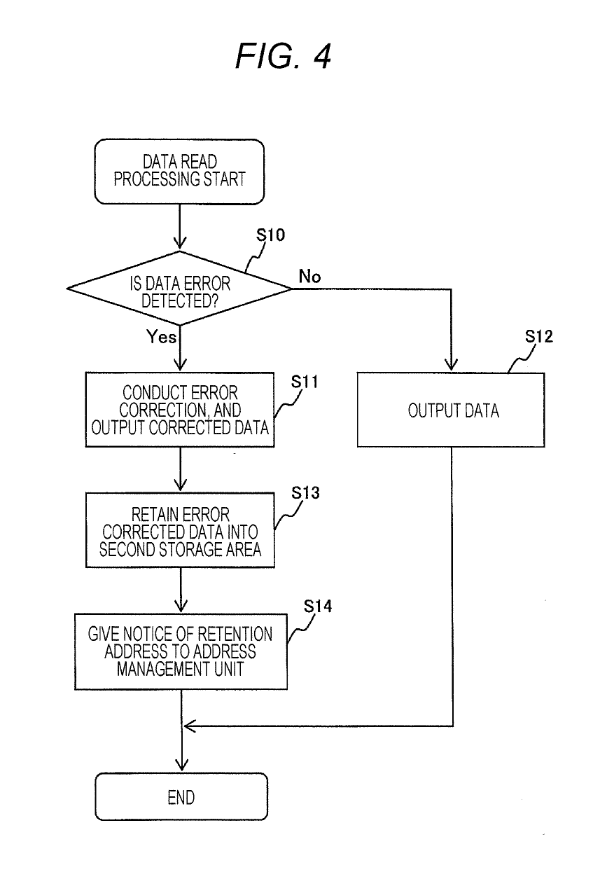

The error detection/correction unit 22 detects a data error in the data 1, corrects the error, and then retains correct data 1 in the address 1. Occurrence of a failure in the memory cell in the address 1 means that there is a possibility of increased vulnerability in the memory cell. Therefore, the data retention/erasure execution unit 23 retains the data 1 after the error correction in an address n (the second storage area A2), which is a vacant area, as well. Detailed processing will be described again with reference to FIG. 4.

The second storage area A2 is supposed to be a vacant area in the data retention unit 21 including the first storage area A1. Instead, however, a vacant area on a different memory, a register in a peripheral module, a vacant area on a memory included in a different microcomputer which is mounted on the electronic control apparatus 1, or the like can also be used. Furthermore, the address of the second storage area A2 may be previously determined at the time of design statically, or may be dynamically searched and determined when the second storage area A2 becomes necessary.

In a case where the ROM 11 is formed of a flash memory, each of the first storage area A1 and the second storage area A2 corresponds to a block which is the unit of data writing/data erasing. When a failure has occurred in some memory cell in a certain block, a data error in the memory cell is corrected and then the entire block is retained in the second storage area A2.

By the way, there is a possibility that a similar data error also occurs in memory cells located near the first storage area A1 on which the data error has occurred. Therefore, it is considered to be desirable to select the second storage area A2 being located as remote from the first storage area A1 in address on the ROM 11 as possible.

FIG. 4 is a diagram showing a processing flow at time when the electronic control apparatus 1 reads data stored in a data retention unit 21. Hereinafter, steps shown in FIG. 4 will be described.

### (FIG. 4: Step S10)

The CPU 10 reads data stored in the data retention unit 21. A storage area on which this data is stored corresponds to the first storage area A1 described with reference to FIG. 3. The error detection/correction unit 22 inspects whether there is a data error in the data read by the CPU 10. In a case where there is no error, the processing proceeds to step S12. In a case where there is an error, the processing proceeds to step S11.

### (FIG. 4: Step S10: Supplement)

In a case where the number of erroneous bits exceeds a range of the number of bits which can be corrected by the error detection/correction unit 22, processing at S11 and subsequent steps is not executed. In this case, the error detection/correction unit 22 outputs a default value preset to be able to control the device safely to the CPU 10.

### (FIG. 4: Step S11)

The error detection/correction unit 22 corrects the data error detected at S10, and outputs the corrected data to the CPU 10. The CPU 10 can continue control processing by using the data for a while.

### (FIG. 4: Step S12)

The error detection/correction unit 22 outputs data subjected to data error inspection to the CPU 10 as it is. The CPU 10 continues the control processing by using the data. After the present step, the present processing flow is finished.

### (FIG. 4: Step S13)

The data retention/erasure execution unit 23 retains data subjected to the error correction conducted by the error detection/correction unit 22 onto the second storage area A2.

### (FIG. 4: Step S14)

The data retention/erasure execution unit 23 gives notice of an address of the second storage area A2 into which the data is retained at the step S13, to the address management unit 24. The address management unit 24 manages correspondence relations between the first storage area A1 and the second storage area A2 in the present processing flow. In other words, the address management unit 24 manages that data stored in the first storage area A1 and data stored in the second storage area A2 are the same data which correspond to each other.

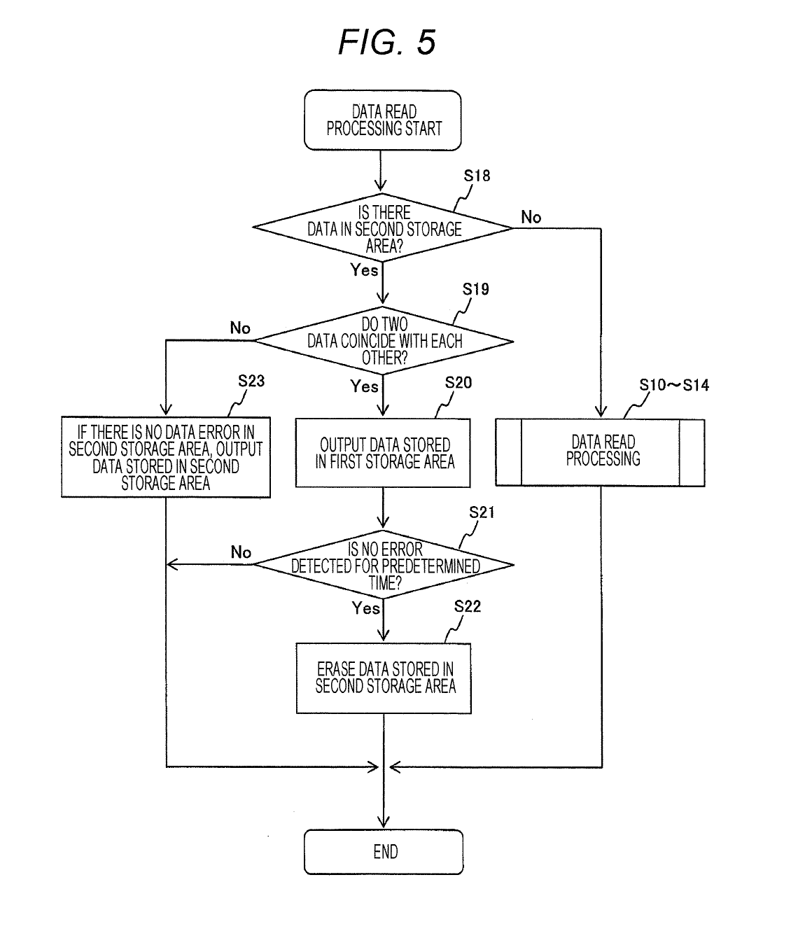

FIG. 5 is a diagram showing a processing flow at time when the electronic control apparatus 1 uses data after correction, after the data after correction is retained in the second storage area A2 by the processing flow shown in FIG. 4. Hereinafter, steps shown in FIG. 5 will be described.

### (FIG. 5: Step S18)

When reading data stored in the data retention unit 21, the CPU 10 inquires of the address management unit 24 and ascertain whether corresponding data generated by correcting a data error on the storage area (corresponding to the first storage area A1 described with reference to FIG. 3) is retained in the second storage area A2. In a case where corresponding data is already retained in the second storage area A2, the processing proceeds to step S19. In a case where corresponding data is not retained in the second storage area A2, the processing proceeds to steps S10 to S14 described with reference to FIG. 4.

### (FIG. 5: Step S19)

The CPU 10 determines whether data on the first storage area A1 and data on the second storage area A2 coincide with each other. In a case where both data coincide with each other, the processing proceeds to step S20. In a case where data do not coincide with each other, the processing proceeds to step S23.

### (FIG. 5: Step S19: Supplement)

The present step is provided considering a possibility that the memory cell becomes vulnerable because a memory failure already occurs in the memory cell in the first storage area A1. In a case where the number of erroneous bits exceeds a range which can be detected by the error detection/correction unit 22, a data error cannot be detected even if the data error occurs. It is possible to find that a data error which cannot be detected even with the error detection function has occurred and enhance the data reliability by comparing data stored in the first storage area A1 and data stored in the second storage area A2 with each other.

### (FIG. 5: Step S20)

The CPU 10 uses the data on the first storage area A1 in the control processing.

### (FIG. 5: Step S21)

The CPU 10 determines whether no data error is detected with respect to the data on the first storage area A1 for at least a predetermined time. In a case where no error is detected for at least a predetermined time, the processing proceeds to step S22. In a case where the predetermined time has not elapsed since a data error is detected lastly, the present processing flow is finished.

### (FIG. 5: Step S22)

In a case where the CPU 10 judges at step S21 that an error has not been detected for at least a predetermined time, the CPU judges that the memory cell in the first storage area A1 is brought into a state in which the memory cell can be used normally again. The data retention/erasure execution unit 23 receives notice to that effect from the CPU 10, and erases the data after the error correction retained in the second storage area A2.

### (FIG. 5: Step S22: Supplement)

At the present step, the data after the error correction retained in the second storage area A2 may be erased at time, for example, when a frequency of data errors occurring within a predetermined time becomes less than a threshold, instead of whether at least a predetermined time has elapsed since a data error is detected lastly.

### (FIG. 5: Step S23)

The error detection/correction unit 22 confirms that a data error is not detected in data on the second storage area A2, and then outputs the data on the second storage area A2 to the CPU 10. In a case where a data error is detected in the data on the second storage area A2, the error detection/correction unit 22 outputs a default value preset to be able to control the device safely, to the CPU 10 in the same way as the step S10. However, the probability that a bit error occurs in the memory cell in the first storage area A1 and in the memory cell in the second storage area A2 simultaneously is considered to be extremely small.

### Embodiment 1

### Summary

When a data error has occurred on the first storage area A1, the electronic control apparatus 1 according to this Embodiment 1 retains error corrected data onto the second storage area A2, and uses both data together under management of correspondence relations conducted between both data by the address management unit 24, as described above. It is possible to ensure reliability of data by retaining the error corrected data onto the second storage area A2. Furthermore, the corrected data is stored onto the second storage area A2 at the time when a data error has occurred. Therefore, it is not necessary to previously secure a storage area for storing the corrected data, and the memory use quantity can be held down.

Furthermore, the electronic control apparatus 1 according to this Embodiment 1 compares the data stored in the first storage area A1 and the data stored in the second storage area A2 with each other, and verifies whether the data coincide with each other. Even in a case where a data error that cannot be detected by using the error detection function has occurred, therefore, it is possible to use correct data.

Furthermore, when the data stored in the first storage area A1 and the data stored in the second storage area A2 do not coincide with each other, the electronic control apparatus 1 according to this Embodiment 1 uses the data on the second storage area A2 thought to have higher reliability. Even in a case where error correction is conducted on the data on the first storage area A1 and then a data error still occurs, therefore, it is possible to execute control processing by using correct data.

### Embodiment 2

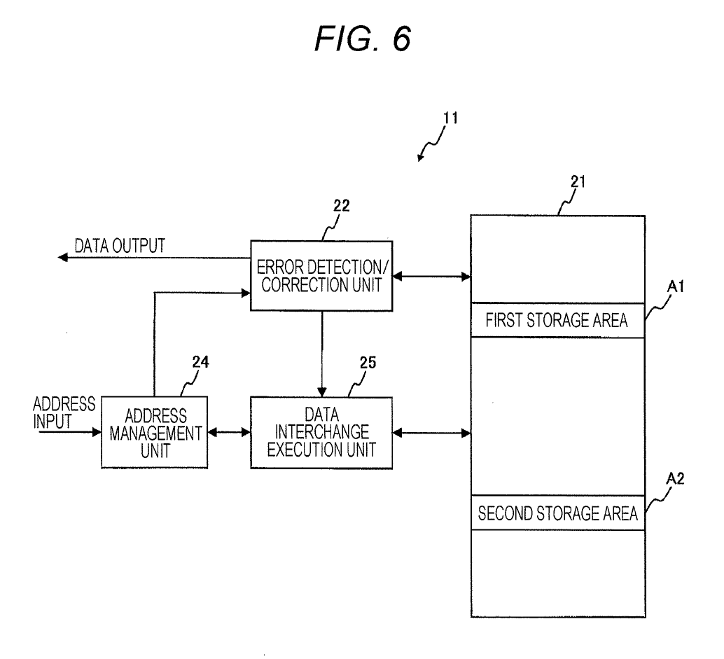

FIG. 6 is a diagram showing a configuration of a program and data stored in a ROM 11 included in an electronic control apparatus 1 according to Embodiment 2 of the present invention. The ROM 11 in this Embodiment 2 stores a data interchange execution unit 25 instead of the data retention/erasure execution unit 23 described in Embodiment 1. Other function units included in the electronic control apparatus 1 are similar to those in Embodiment 1. The same is true of the RAM 12 as well.

If the data interchange execution unit 25 receives notice to the effect that a data error is detected, from the error detection/correction unit 22, the data interchange execution unit 25 performs interchange between data stored in the first storage area A1 and data stored in the second storage area A2. In other words, in this Embodiment 2, it is not necessary that the second storage area A2 is a vacant area. A concrete processing flow will be described later. “Data retention” in this Embodiment 2 corresponds to the data interchange execution unit 25.

The data interchange execution unit 25 can be constituted by using hardware such as a circuit device which implements its function, or can be implemented by causing the CPU 10 to execute software which describes processing of its processing. In a case where the data interchange execution unit 25 is mounted as software, the data interchange execution unit 25 can be stored on the memory as shown in FIG. 2.

The address management unit 24 receives notice to the effect that interchange between data in the first storage area A1 and data stored in the second storage area A2 is performed, from the data interchange execution unit 25, and manages correspondence relations between addresses of data stored in the first storage area A1 and addresses of corresponding data stored in the second storage area A2. The CPU 10 can access these data without being conscious of a change in data arrangement caused by a processing flow described later by inquiring of the address management unit 24 about correspondence relations of these data.

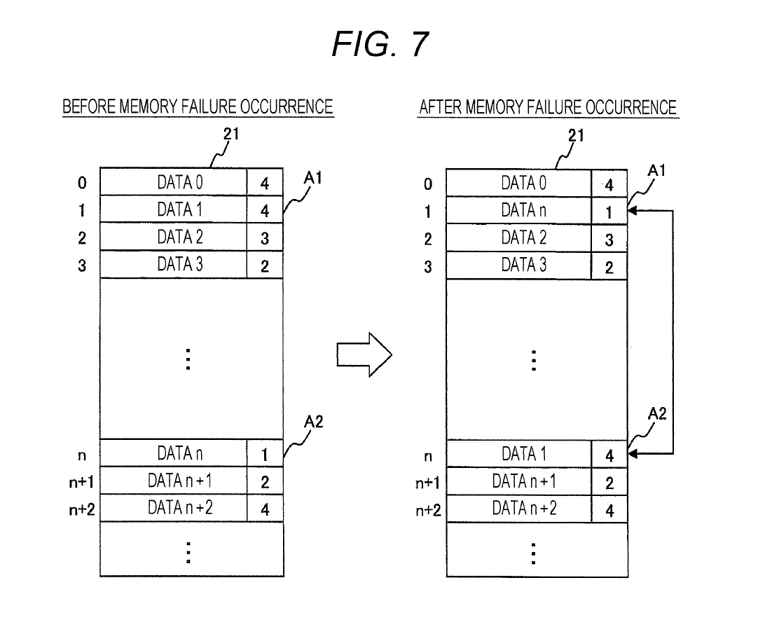

FIG. 7 is a diagram showing a data arrangement in the ROM 11 before and after a memory failure occurs in this Embodiment 2. In this Embodiment 2, each data stored in the data retention unit 21 is provided with importance information which indicates importance of the data. Here, it is supposed that the importance of data is the highest at 4, and becomes lower in the order of 3, 2 and 1.

It is supposed that a failure has occurred in a memory cell in an address 1 (the first storage area A1). The error detection/correction unit 22 detects a data error in data 1 (the importance 4), corrects the error, and then retains correct data 1 in the address 1.

Occurrence of a failure in the memory cell in the address 1 means that there is a possibility of increased vulnerability in the memory cell. Therefore, the data interchange execution unit 25 retains the data 1 after the error correction into an address n (the second storage area A2) in which data n (the importance 1) having importance lower than that of the data 1 is retained. Since the data n is relatively low in importance, the data interchange execution unit 25 retains the data n into the address 1 (the first storage area A1) in which the data 1 was retained. Owing to the processing described above, interchange between the data stored in the first storage area A1 and the data stored in the second storage area A2 is performed.

By the way, in the same way as Embodiment 1, it is desirable that the second storage area A2 is an area located as remote physically from the first storage area A1 as possible. In addition, it is desirable that the second storage area A2 is a storage area storing data which is relatively low in importance in the area. In a case where there are a plurality of candidates for the second storage area A2, a candidate that is lower in importance of stored data should be selected preferentially. In a case where there are a plurality of candidates having the same importance for the second storage area A2, a candidate located as remote in distance from the first storage area A1 as possible should be selected preferentially.

In a case where the ROM 11 is formed of a flash memory, each of the first storage area A1 and the second storage area A2 corresponds to a block which is the unit of data writing/data erasing. When a failure has occurred in some memory cell in a certain block, a data error in the memory cell is corrected and then data interchange between the certain block and a block in which data that is relatively low in importance than the certain block is retained is performed.

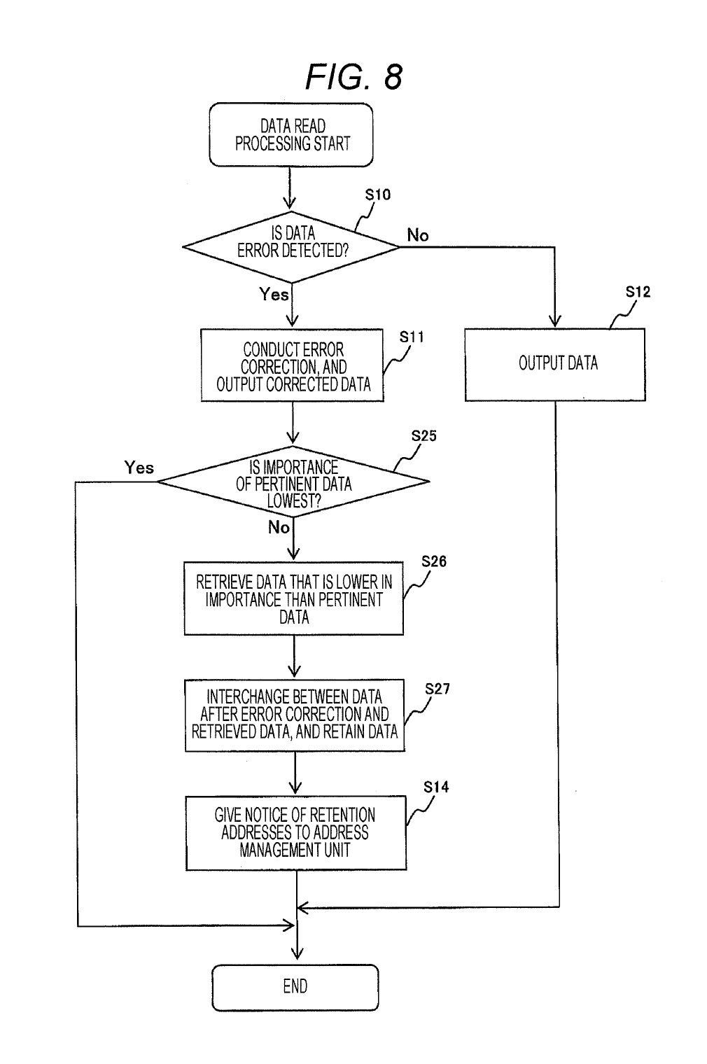

FIG. 8 is a diagram showing a processing flow at the time when the electronic control apparatus 1 reads data stored in the data retention unit 21 in this Embodiment 2. Hereinafter, steps shown in FIG. 8 will be described.

### (FIG. 8: Steps S10 to S12)

These steps are similar to the steps S10 to S12 described with reference to FIG. 4 for Embodiment 1. After the step S11, however, steps S25 to S27 are executed instead of the step S13.

### (FIG. 8: Step S25)

The data interchange execution unit 25 judges the importance of data read by the CPU 10 at the step S10. In a case where the importance is at the lowest level, there is no data to be interchanged with the data in storage area, and consequently the present processing is finished as it is. In a case where the importance is not at the lowest level, the processing proceeds to step S26.

### (FIG. 8: Step S26)

The data interchange execution unit 25 retrieves data lower in importance than data read by the CPU 10 at the step S10, in an order of decreasing physical distance from the first storage area A1 where the data read by the CPU 10 is retained.

### (FIG. 8: Step S27)

The data interchange execution unit 25 performs interchange between data in the second storage area A2 found by the retrieval at the step S26 and the data in the first storage area A1.

### (FIG. 8: Step S27: Supplement)

In this Embodiment 2, data that is relatively low in importance is disposed in a memory cell having a possibility of increasing vulnerability. In a case where a multi-bit error exceeding a range for which the error detection/correction unit 22 can conduct error correction has occurred, a default value preset to be able to control the device safely should be output to the CPU 10 in the same way as the step S10.

### (FIG. 8: Step S14)

The data interchange execution unit 25 gives notice of retention destination addresses of respective data interchanged at the step S26 to the address management unit 24. The address management unit 24 manages correspondence relations between the first storage area A1 and the second storage area A2 in the present processing flow. In other words, the address management unit 24 manages that interchange between the data stored in the first storage area A1 and the data stored in the second storage area A2 is performed.

### Embodiment 2

### Summary

As described above, the electronic control apparatus 1 according to this Embodiment 2 performs data interchange between the first storage area A1 where a data error has occurred and the second storage area A2 that is lower in importance than the data. As a result, it becomes unnecessary to select the second storage area A2 out of vacant areas. Accordingly, it becomes unnecessary to redundantly secure vacant areas for retaining corrected data. Therefore, it is possible to further hold down the memory use quantity.

### Embodiment 3

In Embodiment 3 of the present invention, an operation example in which, when a data error is detected in the first storage area A1, corrected data is not retained in the second storage area A2, but corrected data is retained at time when data errors have continued to some degree will be described. A configuration of the electronic control apparatus 1 is similar to that in Embodiment 1. Hereinafter, therefore, Embodiment 3 will be described laying stress on different points.

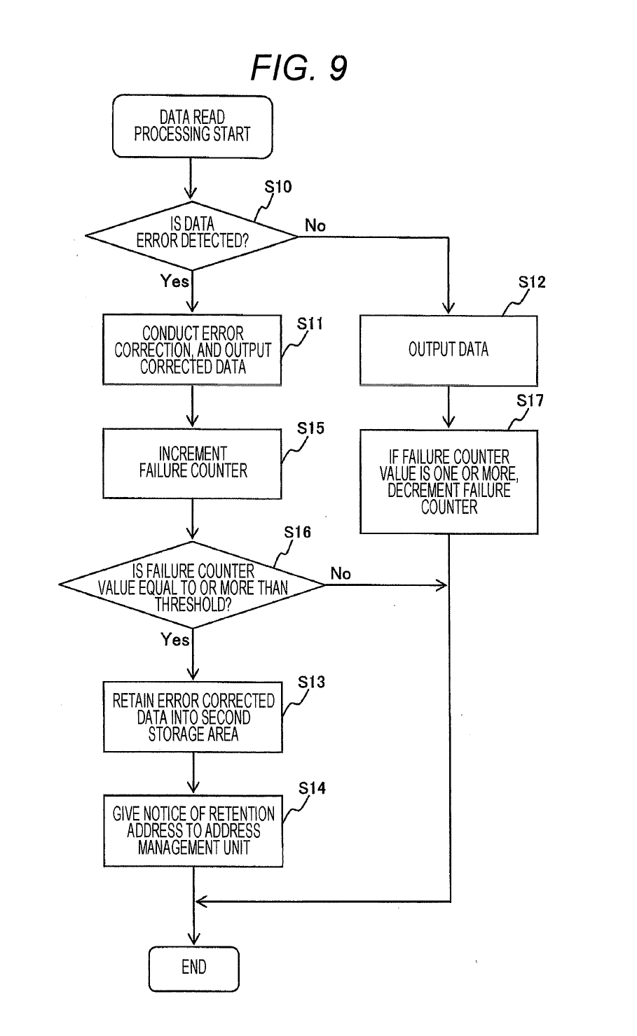

FIG. 9 is a diagram showing a processing flow at the time when the electronic control apparatus 1 reads data stored in the data retention unit 21 in this Embodiment 3. Hereinafter, steps shown in FIG. 9 will be described.

### (FIG. 9: Steps S10 to S12)

These steps are similar to the steps S10 to S12 described with reference to FIG. 4 in Embodiment 1. However, steps S15 to S16 are executed between the step S11 and the step S13, and step S17 is executed after the step S12.

### (FIG. 9: Step S15)

The error detection/correction unit 22 increases a value in a failure counter retained internally.

### (FIG. 9: Step S16)

The error detection/correction unit 22 determines whether the failure counter value has exceeded a predetermined threshold. In a case where the failure counter value has exceeded a predetermined threshold, the processing proceeds to step S13. In a case where the failure counter value has not exceeded a predetermined threshold, the present processing is finished without retaining error corrected data into the second storage area A1. Each time data is read from the first storage area A1, the present step is executed. Accordingly, in a case where a data error occurs due to a temporary cause, data is not retained into the second storage area A2 immediately, but it is possible to inquire into the state of things once as to whether a data error occurs continuously.

### (FIG. 9: Step S17)

In a case where a data error is not detected at the step S10 and the failure counter value is at least one, the error detection/correction unit 22 decreases the failure counter value. Each time data is read from the first storage area A1, the present step is executed. In a case where the data error occurs due to a temporary cause, therefore, the failure counter finally becomes zero. As a result, ensuing processing can be conducted considering that a data error does not occur in the first storage area A1.

### Embodiment 3

### Summary

As described above, the electronic control apparatus 1 according to this Embodiment 3 determines whether a data error occurs at the time when the CPU 10 reads data from the first storage area A1, and counts the number of times a data error occurred. In a case where the counter value exceeds the threshold, corrected data is retained in the second storage area A2. Otherwise, corrected data is not retained. As a result, it is prevented to retain data in which a data error has occurred due to a temporary memory failure, into the second storage area A2 unnecessarily. It is possible to hold down waste of the processing load and memory capacity.

### Embodiment 4

Embodiments 1 to 3 can be combined suitably and used. Furthermore, apart of components can be modified. For example, a combination example and a modification example, described hereinafter are conceivable.

### Combination of Embodiments

### Example 1

The processing of performing data interchange between the first storage area A1 and the second storage area A2 described in Embodiment 2 is executed at the time when the failure counter has exceeded the threshold described in Embodiment 3.

### Combination of Embodiments

### Example 2

The importance information of data described in Embodiment 2 is introduced into Embodiment 1. It is determined whether to retain data after error correction into the second storage area A2 redundantly on the basis of importance of the data after error correction.

### Modification Example of Embodiments

The threshold of the failure counter in Embodiment 2 and the predetermined time described with reference to the step S21 in Embodiment 1 are made variable depending upon importance of data.

The invention made by the present inventor has been specifically described above on the basis of the embodiments. However, the present invention is not restricted to the embodiments. It is a matter of course that various changes can be made without departing from the spirit of the invention.

Furthermore, as for each of the above-described configurations, functions, and processing units, the whole or apart can be implemented as hardware by, for example, designing as an integrated circuit, or can also be implemented as software by causing a processor to execute programs that implement respective functions. Information such as programs and tables for implementing respective functions can be stored in a storage device such as a memory or a hard disk, or a storage medium such as an IC card or a DVD.

### REFERENCE SIGNS LIST

1 electronic control apparatus
2 microcontroller
3 input circuit
4 output circuit
5 power supply circuit
10 CPU
11 ROM
12 RAM
13 peripheral bus controller
14 A/D converter
15 timer
16 communication interface
17 oscillator
18 internal bus
19 peripheral bus
21 data retention unit
22 error detection/correction unit
23 data retention/erasure execution unit
24 address management unit
25 data interchange execution unit
A1 first storage area
A2 second storage area

1. An electronic control apparatus comprising:
a memory which stores data;
a processor which executes control processing by using data stored in the memory;
an error detection unit which detects a data error in data stored in the memory;
an error correction unit which corrects the data error; and
a data retention unit which retains data stored in the memory into a different storage area on the memory,
wherein
when the error detection unit detects the data error, the data retention unit retains data obtained as a result of correction of the data error conducted by the error correction unit into a second storage area different from a first storage area on the memory where the data error is detected, and
after the data retention unit retains data into the second storage area, the processor uses the data on the second storage area for the control processing, and uses data on the first storage area as well for the control processing continuously.

2. The electronic control apparatus according to claim 1, comprising an address management unit which manages correspondence relations between addresses in the first storage area on the memory and addresses in the second storage area,
wherein
the processor inquires of the address management unit whether the data retention unit has retained data obtained by conducting error correction on data on the first storage area onto the second storage area, and
in a case where data corresponding to the data on the first storage area exists on the second storage area, the processor uses the data on the first storage area and the data on the second storage area jointly.

3. The electronic control apparatus according to claim 2, wherein the data retention unit retains the data after the correction retained in the second storage area into the first storage area as well.

4. The electronic control apparatus according to claim 3, wherein
when using the data on the first storage area in the control processing, the processor inquires of the address management unit whether data corresponding to the data on the first storage area exists on the second storage area, and
in a case where data corresponding to the data on the first storage area exists on the second storage area, the processor compares both data with each other, and in a case where both data coincide with each other, the processor uses the data stored in the first storage area.

5. The electronic control apparatus according to claim 3, wherein
when using the data on the first storage area in the control processing, the processor inquires of the address management unit whether data corresponding to the data on the first storage area exists on the second storage area, and
in a case where data corresponding to the data on the first storage area exists on the second storage area, the processor compares both data with each other, and in a case where both data do not coincide with each other, the processor uses the data stored in the second storage area.

6. The electronic control apparatus according to claim 3, wherein
when using the data on the first storage area in the control processing, the processor inquires of the address management unit whether data corresponding to the data on the first storage area exists on the second storage area,
in a case where data corresponding to the data on the first storage area exists on the second storage area, the processor compares both data with each other, and in a case where both data do not coincide with each other, the processor inquires of the error detection unit whether a data error occurs in corresponding data stored in the second storage area, and
in a case where a data error has not occurred, the processor uses the corresponding data stored in the second storage area, and in a case where a data error has occurred, the processor uses a predetermined default value.

7. The electronic control apparatus according to claim 1, wherein
the data retention unit measures a frequency of data errors occurring in the first storage area for s predetermined time or an elapsed time from time when a data error occurred in the first storage area lastly, and
when the frequency is lower than a predetermined threshold, or the elapsed time is at least a predetermined reference time, the data retention unit conducts error correction on data on the first storage area and then erases data retained on the second storage area.

8. The electronic control apparatus according to claim 1, wherein
the data retention unit uses a storage area having an address on the memory which is located as remote from the first storage area as possible, as the second storage area preferentially.

9. The electronic control apparatus according to claim 2, wherein, in the data retention unit, when the error detection unit has detected the data error, the error correction unit retains error corrected data into the second storage area, and retains data stored in the second storage area before then into the first storage area.

10. The electronic control apparatus according to claim 9, wherein
the memory stores importance information which indicates importance of data together with the data, and
when the error detection unit has detected the data error with respect to data stored in the first storage area, the data retention unit identifies importance of the data for which the data error is detected on the basis of the importance information, and
the data retention unit retains data obtained as a result of error correction conducted by the error correction unit, into the second storage area where data having importance lower than the identified importance is stored, retains data stored in the second storage area before then into the first storage area, and thereby performs interchange between data stored in the first storage area and data stored in the second storage area.

11. The electronic control apparatus according to claim 9, wherein
the data retention unit uses a storage area having an address on the memory which is located as remote from the first storage area as possible, as the second storage area preferentially.

12. The electronic control apparatus according to claim 10, wherein
the data retention unit uses a storage area storing data having importance which is as low as possible, as the second storage area preferentially, and
in a case where there are a plurality of storage areas storing data which are equal in importance as candidates for the second storage area, the data retention unit uses a storage area having an address on the memory which is more remote from the first storage area, as the second storage area preferentially.

13. The electronic control apparatus according to claim 1, wherein
only in a case where number of times of occurrence of data error detected by the error detection unit exceeds a predetermined threshold at time when the processor reads data from the first storage area, the data retention unit retains data obtained as a result of correction of the data error conducted by the error correction unit, into the second storage area.

14. The electronic control apparatus according to claim 13, wherein
in a case where the error detection unit has not detected the data error, the data retention unit decreases a counter value of the number of times of occurrence.

15. The electronic control apparatus according to claim 1, comprising a second memory different from the memory,
wherein the data retention unit uses a storage area on the second memory as the second storage area.
